(19) United States
(12) Patent Application Publication
(10) Pub. No.: US 2021/0061196 A1
(43) Pub. Date: Mar. 4, 2021

(54) PIPE AND WIRE HARNESS

(71) Applicant: SUMITOMO WIRING SYSTEMS, LTD., Yokkaichi-shi (JP)

(72) Inventor: Naoki AOYAMA, Yokkaichi-shi (JP)

(73) Assignee: SUMITOMO WIRING SYSTEMS, LTD., Yokkaichi-shi (JP)

(21) Appl. No.: 16/993,862

(22) Filed: Aug. 14, 2020

(30) Foreign Application Priority Data
Aug. 26, 2019 (JP) 2019-153395

(51) Int. Cl. B60R 16/02; F28F 1/42

(52) U.S. Cl. CPC B60R 16/0215; F28F 1/422

(57) ABSTRACT

A wire harness that includes a pipe configured to have a wire inserted into an internal portion thereof, the pipe including a body with an areally increased portion, wherein the areally increased portion has recesses formed into a peripheral surface of the body, and a plurality of wires that are configured to be inserted inside the body. disclosure

### BACKGROUND

The present disclosure relates to a pipe and a wire harness.

JP 2010-186601A (FIG. 4) discloses a metal pipe. The pipe includes a wire inserted therein. The outer peripheral surface of the pipe is provided with a plurality of protruding parts. The protruding parts are arranged on the outer peripheral surface of the pipe with fixed spaces therebetween in the circumferential direction of the pipe. The pipe that includes the protruding parts is manufactured through extrusion molding. The conductive body of the wire generates heat when the wire conducts electricity. The heat that is generated in the conductive body is transmitted to the pipe and is released into the air from the outer peripheral surface of the pipe. Heat dissipation can be improved by providing the plurality of protruding parts on the outer peripheral surface of the pipe. JP 2013-211963A, JP 2002-279832A, and JP 2015-192003A also disclose structures in which wires conduct electricity.

JP 2010-186601A (FIG. 4), JP 2013-211963A, JP 2002-279832A, and JP 2015-192003A are examples of related art.

### SUMMARY

With JP 2010-186601A, there is concern that the portion of the pipe from which the protruding parts protrude radially outward may radially increase the size of the pipe. Also, the protruding parts are formed through extrusion molding, and therefore have a continuous shape with the same cross-section thereof in the axial direction of the pipe. For this reason, a problem with this configuration is that there is a low degree of freedom in the shape of the pipe.

An exemplary aspect of the disclosure provides a pipe and a wire harness with which it is possible to improve heat dissipation and the degree of freedom in the shape thereof, while keeping the pipe from becoming radially enlarged.

The pipe according to an exemplary aspect of the present disclosure is configured to have a wire inserted into an internal portion thereof, the pipe including: a body with an areally increased portion, wherein the areally increased portion has recesses formed into a peripheral surface of the body.

The wire harness of the present disclosure includes the pipe and a plurality of wires that are to be inserted into an inner portion of the pipe.

With the present disclosure, it is possible to provide a pipe and a wire harness with which it is possible to improve heat dissipation and the degree of freedom in the shape thereof, while keeping the pipe from becoming radially enlarged.

### BRIEF DESCRIPTION OF THE DRAWINGS

FIG. 1 is a schematic side view showing a wire harness according to a first embodiment in a state in which a pipe is attached to an automotive body.

FIG. 2 is an enlarged side view showing the wire harness according to the first embodiment in a state in which the pipe is attached to the automotive body via a clamp.

FIG. 3 is an enlarged side view showing a portion of the pipe of the wire harness according to the first embodiment, the shown portion including a straight-pipe portion and a bent-pipe portion.

FIG. 4 is a sectional view of the wire harness according to the first embodiment taken at a position passing through an areally increased portion.

FIG. 5 is an enlarged side view of a portion of the pipe according to the first embodiment, the shown portion including the areally increased portion.

FIG. 6 is a sectional view corresponding to FIG. 4 and shows the wire harness according to a second embodiment.

FIG. 7 is a sectional view corresponding to a portion of FIG. 4 and shows the wire harness according to a third embodiment.

FIG. 8 is a sectional view corresponding to FIG. 3 and shows a portion of the pipe of the wire harness according to a fourth embodiment.

FIG. 9 is a sectional view corresponding to FIG. 4 and shows the wire harness according to the fourth embodiment.

FIG. 10 is an enlarged side view corresponding to FIG. 2 and shows the wire harness according to the fourth embodiment

### DETAILED DESCRIPTION OF EMBODIMENTS

First, embodiments of the present disclosure will be listed and described.

The pipe according to the present disclosure is:

(1) A pipe configured to have a wire inserted into an internal portion thereof, including an areally increased portion, wherein the areally increased portion has a shape that is recessed into a peripheral surface of the pipe.

With this configuration, the pipe includes the areally increased portion and it is therefore possible to increase the heat-dissipating area of the pipe. As a result, it is possible to improve the heat dissipation of the pipe. The areally increased portion is recessed into the peripheral surface of the pipe, and it is thus possible to keep the pipe from becoming radially enlarged. Also, the areally increased portion can be recessed into the peripheral surface of the pipe through post-processing, and it is thus possible to improve the degree of freedom in the shape of the pipe.

(2) The areally increased portion preferably includes an embossed recessed portion provided around a protruding portion.

With this configuration, it is possible to further increase the degree of freedom in the shape of the areally increased portion. In particular, the areally increased portion can be formed into a thin shape, and can therefore be suitably applied to a pipe with a small diameter.

(3) The areally increased portion preferably includes a plurality of dimpled recessed portions provided individually.

With this configuration, it is possible to further increase the degree of freedom in the shape of the areally increased portion. Also, it is possible to suitably adjust the area of the peripheral surface of the pipe that is occupied by the recessed portion.

(4) It is sufficient that the areally increased portion is provided on a lower portion of a peripheral surface of the pipe.

With this configuration, if the wire is in contact with the lower portion of the inner peripheral surface of the pipe due to the weight of the wire, heat generated by the wire can be effectively dissipated into the air (atmosphere) via the areally increased portion that is provided on the lower portion of the peripheral surface of the pipe.

(5) It is sufficient that the pipe includes a straight-pipe portion that extends in an axial direction and a bent-pipe portion that is bent in a direction that intersects the axial direction, and the areally increased portion is not provided on the bent-pipe portion and is provided on the straight-pipe portion.

With this configuration, it is possible to form the areally increased portion on the straight-pipe portion of the pipe with good accuracy through post-processing.

(6) It is sufficient that the areally increased portion is provided on an outer peripheral surface of the pipe.

With this configuration, the areally increased portion is in direct contact with the air (atmosphere), and it is thus possible to further improve heat dissipation.

(7) It is sufficient that the areally increased portion is also provided on an inner peripheral surface of the pipe.

With this configuration, the area of the pipe from which heat is dissipated can be further increased, and it is thus possible to further improve the heat dissipation.

Also, the wire harness of the present disclosure:

(8) A wire harness including the pipe and a plurality of wires that are configured to be inserted into an inner portion of the pipe.

With this configuration, the present disclosure can be applied to a wide range of different types of wire harnesses.

(9) It is sufficient that the wire harness further includes a clamp that is configured to attach the pipe to an automotive body, wherein the areally increased portion is provided, in an outer peripheral surface of the pipe, as a portion including an embossed recessed portion provided around a protruding portion, or as a portion including a plurality of dimpled recessed portions provided individually, and the clamp is configured to hold a region of an outer peripheral surface of the pipe that includes the areally increased portion.

With this configuration, the areally increased portion functions to improve the heat dissipation of the pipe, and also functions to prevent slippage between the pipe and the clamp. For this reason, it is possible to increase the functionality of the areally increased portion.

### Details of the Embodiments of the Disclosure

Specific examples of a pipe and a wire harness of the present disclosure will be described below with reference to the drawings.

### First Embodiment

A wire harness W1 according to a first embodiment may be, for example, installed in an electric automobile or a hybrid vehicle. The wire harness W1 includes a plurality (two in the present embodiment) of wires 30, and a pipe 10 that collectively protects all of the wires 30. Note that in regards to the up-down direction in the following description, downward (downward in the direction of gravity) and upward when the wire harness W1 is installed in an automotive body B are respectively downward and upward in the description.

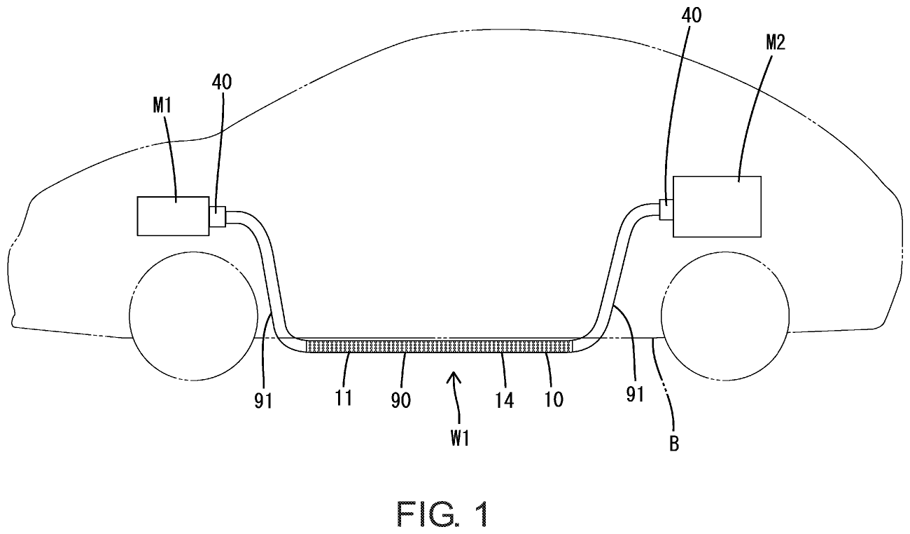

As shown in FIG. 1, the wire harness W1 connects a device (such as a motor or an inverter) M1 that is installed in a front portion of a vehicle to a device (such as a high-voltage battery) M2 that is installed in a rear portion of the vehicle. The wire harness W1 is arranged from the front portion to the rear portion of the vehicle. The wire harness W1 includes an underfloor region 90 which is arranged under the floor of the vehicle. The wire harness W1 includes raised regions 91 that rise from the front and rear ends of the underfloor region 90 and are connected to the devices M1 and M2.

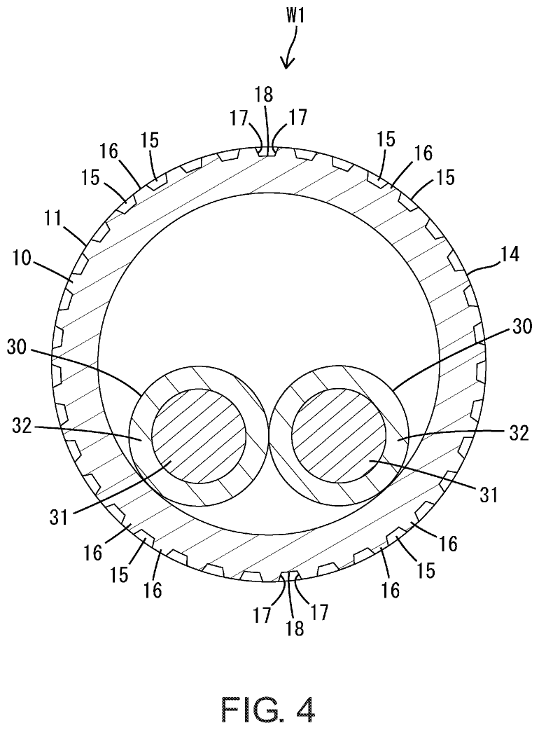

As shown in FIG. 4, the wires 30 include conductive portions 31, and cover portions 32 that cover the conductive portions 31. The conductive portions 31 are made of an electrically conductive metal, and may be formed by stranding together a plurality of metallic wires, for example. The cover portions 32 are made of an insulating resin and are formed over the entire periphery of the conductive portions 31. The wires 30 are ordinary wires that do not have shielding functionality. The end portions of the wires 30 are connected to a terminal fitting (not shown). The metal fitting is accommodated in an internal portion of a connector 40. As shown in FIG. 1, the connector 40 is connected to the devices M1 and M2.

Although not shown in the drawings, the portions of the wires 30 towards the ends thereof are exposed between the pipe 10 and the devices M1 and M2. The wire harness W1 includes a shield member (not shown) that encases the portions of the wires 30 towards the end portions thereof. The shield member may be, for example, a braided member in which fine metallic wires are braided together into a tubular shape. The shield member has a shielding property and is flexible, and other than the braided member, may be constituted by a metal foil, a metal tape, or the like. One end of the shield member is connected to an end of the pipe 10. The other end of the shield member is connected to the connector 40. The pipe 10 and the shield member mask electromagnetic noise generated by the wires 30.

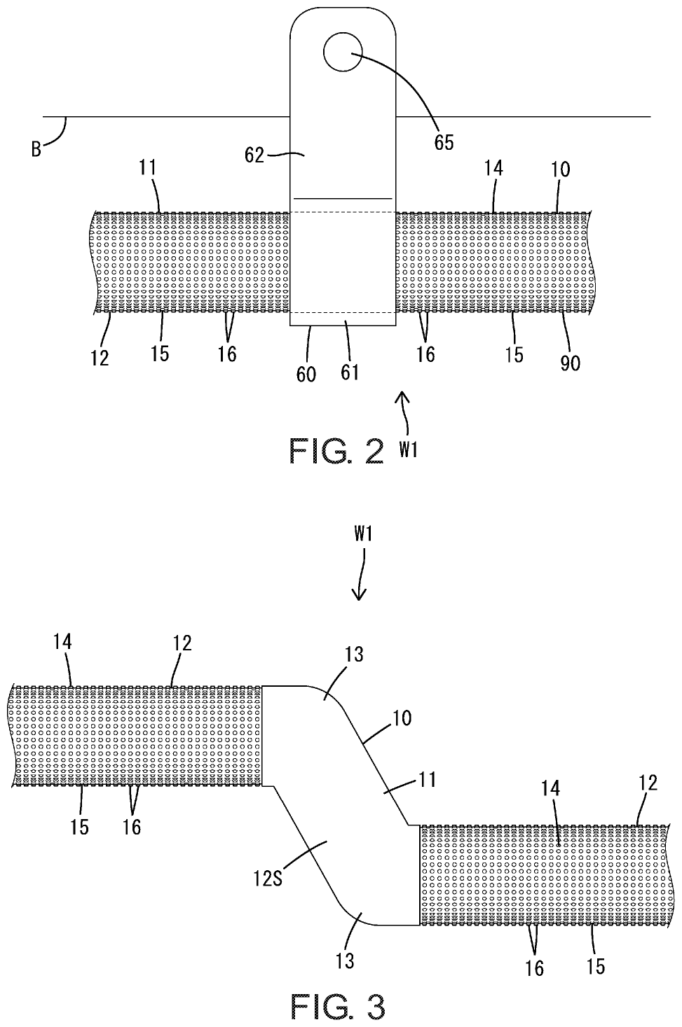

As shown in FIGS. 1 and 2, the underfloor region 90 of the pipe 10 includes an underfloor portion 11 that is arranged under the floor of the vehicle. The pipe 10 also serves to protect the wires 30 in the underfloor region 90 from outside interference with foreign bodies.

The pipe 10 is a long, metal tubing material made from at least one metal selected from, for example, copper, a copper alloy, aluminum, or an aluminum alloy. The pipe 10 has a shielding property and is able to retain the shape thereof. The pipe 10 is bent with the use of a bending machine or the like. Here, “able to retain the shape thereof” means that the pipe 10 is rigid and retains the shape thereof (a strait shape or a bent shape) as long as the pipe 10 is not bent with the use of a bending machine or the like. On the other hand, the wires 30 and the shield member are flexible.

The underfloor portion 11 of the pipe 10 is arranged so as to extend in the front-rear direction parallel to the underfloor of the vehicle. Of course, the underfloor portion 11 of the pipe 10 may also include a portion that is arranged on an incline with respect to the front-rear direction.

As shown in FIG. 3, the underfloor portion 11 of the pipe 10 includes straight-pipe portions 12 and bent-pipe portions 13. The straight-pipe portions 12 have a linear shape that extends in the front-rear direction or in an inclined direction.

The bent-pipe portions 13 are bent in a direction that intersects with the straight-pipe portions 12 (a direction that intersects with the front-rear direction or with the inclined direction) at a mid-way point along the pipe 10 in the axial direction (the length direction; the front-rear direction) thereof. For example, the bent-pipe portions 13 are formed by being bent in the width direction (the width direction of the vehicle) by a bending machine or the like. The bent-pipe portions 13 include bent portions that are formed by bending the pipe 10 and are shaped like the letter “L” or like the letter “U”.

As shown in FIG. 3, the straight-pipe portions 12 of the underfloor portion 11 of the pipe 10 include areally increased portions 14. Compared to a case where the pipe 10 does not include the areally increased portions 14 (for example, if the outer peripheral surface of the pipe 10 is formed without protrusions or recesses), the areally increased portions 14 are the portions of the outer peripheral surface of the pipe 10 that have been processed so as to increase the surface area. In the present embodiment, the areally increased portions 14 are provided on the straight-pipe portions 12 that are long and extend in the axial direction of the pipe 10, and are not provided on the straight-pipe portions 12 (shown as a straight-pipe portion 12S in FIG. 3) that are short and are positioned between the adjacent bent-pipe portions 13.

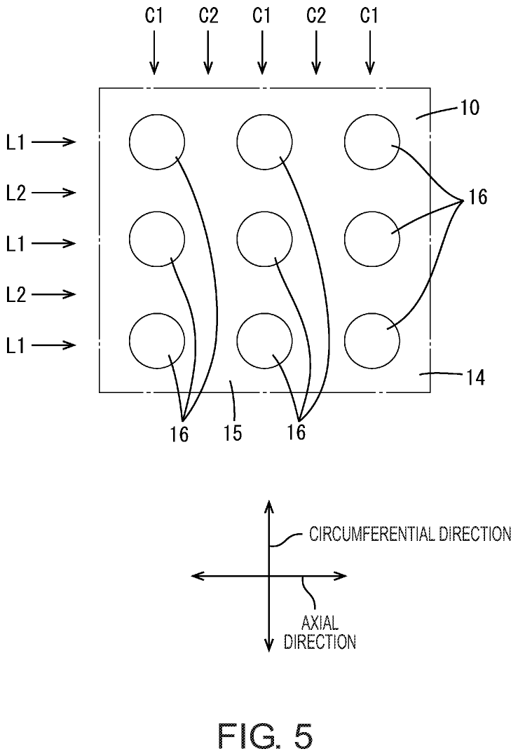

The areally increased portions 14 are formed recessed into the outer peripheral surface of the pipe 10. Specifically, as shown in FIG. 4, the areally increased portions 14 include embossed recessed portions 15 (recessed portions that are embossed) that are arranged with spaces therebetween in the circumferential direction of the pipe 10. The embossed recessed portions 15 that are adjacent in the circumferential direction are partitioned by protruding portions 16. In other words, a plurality of the protruding portions 16 are lined up on the outer peripheral surface of the pipe 10 via the embossed recessed portions 15. The protruding portions 16 have a columnar shape and have a circular cross-section (see FIG. 5). Of course, configurations are also possible in which the protruding portions have a polygonal cross-section such as that of a rectangle, a square, a parallelogram, a trapezoid, or a triangle.

Both end surfaces of the protruding portions 16 in the circumferential direction partition the end surfaces in the circumferential direction of the embossed recessed portions 15 adjacent in the circumferential direction. Both end surfaces of the protruding portions 16 in the circumferential direction are constituted by a pair of inclined surfaces 17, as shown in FIG. 4. The inclined surfaces 17 have a tapered shape and the opposing distance therebetween decreases as the inclined surfaces 17 approach the inner side (bottom surfaces 18) in the radial direction of the pipe 10. The end surfaces of the protruding portions 16 in the protruding direction thereof and the bent-pipe portions 13 are arranged in the same position in the radial direction in the pipe 10, and define the outer peripheral surface of the pipe 10.

The bottom surfaces 18 of the embossed recessed portions 15 are surfaces between the inclined surfaces 17 that face each other in the circumferential direction, and connect both of the inner ends (between the bottom ends) of the inclined surfaces 17 in the radial direction.

The inner peripheral surface of the pipe 10 has a circular shape in cross-section, and is continuous over the entire periphery of the pipe 10 without any protrusions or recesses. The inner peripheral surface of the pipe 10 is arranged parallel with the end surfaces of the protruding portions 16 in the protruding direction thereof and the bottom surfaces 18.

As shown in FIG. 5, a plurality of the protruding portions 16 are arranged aligned in the circumferential direction and the axial direction of the pipe 10. The protruding portions 16 that are lined up in the circumferential direction of the pipe 10 are arranged in the same positions in the axial direction of the pipe 10. The protruding portions 16 lined up in the axial direction of the pipe 10 are arranged in the same positions in the circumferential direction of the pipe 10.

As shown in FIG. 5, the areally increased portions 14 of the pipe 10 alternately include rows in which the embossed recessed portions 15 are arranged with spaces therebetween in the circumferential direction via the protruding portions 16 (the columns denoted by the reference numeral “C1” in FIG. 5), and columns in which the embossed recessed portions 15 are arranged continuously in the circumferential direction not via the protruding portions 16 (the columns denoted by the reference numeral “C2” in FIG. 5). Also, the areally increased portions 14 of the pipe 10 alternately include lines in which the embossed recessed portions 15 are arranged in the axial direction with spaces therebetween via the protruding portions 16 (the lines denoted by the reference numeral “L1” in FIG. 5), and lines in which the embossed recessed portions 15 are arranged continuously in the axial direction not via the protruding portions 16 (the lines denoted by the reference numeral “L2” in FIG. 5). The embossed recessed portions 15 are in mutual communication and are formed as a single body in the portions thereof in which the circumferential direction and the axial direction intersect. To put it simply, the embossed recessed portions 15 are provided around the protruding portions 16 so as to surround the entire circumference of each of the protruding portions 16. The protruding portions 16 and the embossed recessed portions 15 are formed by embossing the outer peripheral surface of the pipe 10.

As shown in FIG. 2, the pipe 10 is attached to the automotive body B in the underfloor portion 11 via a clamp 60. The clamp 60 may be made of a metal or a synthetic resin, and includes a holding portion 61 and an attachment portion 62. The attachment portion 62 extends from the holding portion 61 towards the automotive body B. The attachment portion 62 is fixed to the automotive body B via a fixing member 65 such as a bolt.

The holding portion 61 is fitted to the areally increased portions 14 of the pipe 10 from the outside thereof, and holds the pipe 10. The holding portion 61 includes an inner surface that is in contact with the outer peripheral surface of the pipe 10. The inner surface of the holding portion 61 has a circular arc-shaped or circular cross-section along the outer peripheral surface of the pipe 10. The inner surface of the holding portion 61 is in contact with the end surfaces of the protruding portions 16 of the areally increased portions 14 in the protruding direction thereof.

The following is a description of an example of a method of manufacturing the pipe 10 and the wire harness W1 of the present embodiment.

First, the base material of the pipe 10, which has a circular tube shape overall, is formed through extrusion molding. Next, a molding material (not shown) corresponding to the protruding portions 16 and the embossed recessed portions 15 is pressed against the outer peripheral surface of the base material of the pipe 10. The outer peripheral surface of the pipe 10 is plastically deformed by the pressing described above. The areally increased portions 14, which include the protruding portions 16 and the embossed recessed portions 15, are formed on the outer peripheral surface of the pipe 10. Also, a plurality of wires 30 are inserted into the inner portion of the pipe 10.

Next, the pipe 10 is bent by a bending machine. The bent-pipe portions 13 are formed in the pipe 10 through this bending. Distortion occurs in the bent-pipe portions 13 due to the tensile stress caused by the bending. As shown in FIG. 3, the areally increased portions 14 in the present embodiment are formed on the straight-pipe portions 12, and therefore the bent-pipe portions 13 are unlikely to be affected by the distortion. As a result, it is possible to accurately retain the shapes of the protruding portions 16 and the embossed recessed portions 15 in the straight-pipe portions 12.

Next, the clamp 60 is attached to the outer peripheral surface of the pipe 10. As shown in FIG. 2, the holding portion 61 of the clamp 60 holds the areally increased portions 14 of the pipe 10. The areally increased portions 14 are formed with fine protrusions and recesses by the protruding portions 16 and the embossed recessed portions 15. It is thus possible for the inner surface of the holding portion 61 to be in contact with the areally increased portions 14 without slipping. As a result, the clamp 60 is attached to the pipe 10 with no positional displacement in the circumferential direction. The wire harness W1 is manufactured as described above.

The following is a description of the effects of the present embodiment.

As shown in FIG. 4, the wires 30 are in contact with the lower portion of the inner peripheral surface of the pipe 10, due to their own weight, in the underfloor portion 11 of the pipe 10. The conductive portions 31 of the wires 30 generate heat when the wires 30 conduct electricity. The heat of the conductive portions 31 is transmitted to the lower portion of the inner peripheral surface of the pipe 10 via the cover portions 32. Furthermore, the heat of the conductive portions 31 is transmitted via the areally increased portions 14 to the outer peripheral surface of the pipe 10 and is released into the air (the atmosphere). Here, the surface area of the outer peripheral surface of the pipe 10 that includes the areally increased portions 14 is increased, and thus the heat dissipating surface area is increased. For this reason, the heat of the conductive portions 31 is more efficiently released from the areally increased portions 14 into the air.

The areally increased portions 14 are exposed to the air from the outer peripheral surface of the pipe 10 and therefore provide excellent heat dissipation.

Also, by forming the embossed recessed portions 15 formed around the protruding portions 16 to be smaller, it is possible for the areally increased portions 14 to be formed in suitable locations, and it is possible to increase the degree of freedom in forming the areally increased portions 14. Also, this can be suitably applied to a pipe 10 of a small diameter.

Also, after the base material of the pipe 10 is extrusion molded, the areally increased portions 14 are formed through pressing. Therefore, the areally increased portions 14 need not be formed in a shape that is uniform in the axial direction of the pipe 10, and it is possible to improve the degree of freedom in the shape of the pipe 10. Furthermore, it is possible to avoid the pipe 10 increasing in size in the radial direction thereof due to the areally increased portions 14.

Moreover, the areally increased portions 14 function to increase heat dissipation, and also functions to prevent slippage between the pipe 10 and the clamp 60. Accordingly, there is no need to separately add a function to the wire harness W1 to stop the clamp 60 slipping, and it is thus possible to simplify the structure of the wire harness W1.

### Second Embodiment

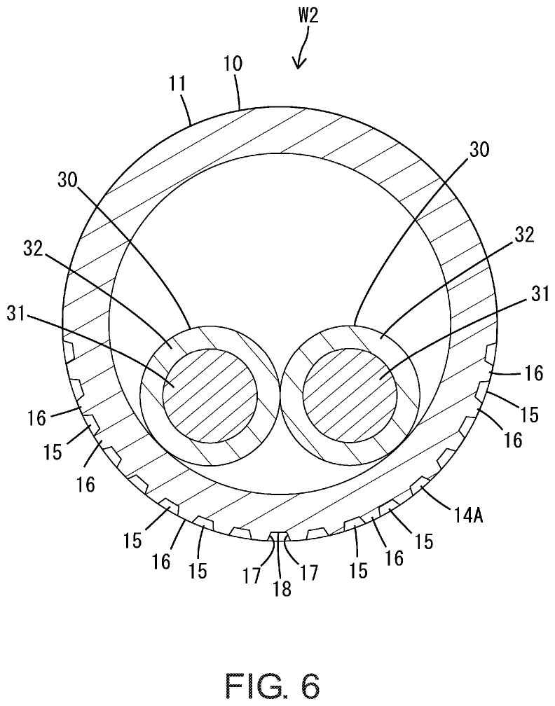

FIG. 6 is a cross-sectional view of a wire harness W2 according to a second embodiment. The second embodiment includes an areally increased portion 14A on the outer peripheral surface of the pipe 10. The areally increased portion 14A includes the protruding portions 16 and the embossed recessed portions 15. These points are similar to the first embodiment.

The range in which the areally increased portion 14A is formed in the second embodiment is limited to the lower portion of the pipe 10. Specifically, the areally increased portion 14A is provided on the lower half portion (the semi-circumferential region on the lower side of the pipe 10) of the outer peripheral surface of the pipe 10. The areally increased portion 14A is not provided on the upper portion (the upper half of the pipe 10) of the outer peripheral surface of the pipe 10. Accordingly, the upper portion of the outer peripheral surface of the pipe 10 is arranged parallel to the inner peripheral surface of the pipe 10.

The wires 30 come into contact with the lower portion of the inner peripheral surface of the pipe 10 due to their own weight. Heat that is generated by the conductive portions 31 when the wires 30 conduct electricity is transmitted from the inner peripheral surface of the lower portion of the pipe 10 to the areally increased portion 14A, and is released from the areally increased portion 14A into the air. These points are similar to the first embodiment.

The areally increased portion 14A is not provided on the upper portion of the outer peripheral surface of the pipe 10 in the second embodiment, and therefore it is possible to simplify such aspects as the structure of the molding material used to form the areally increased portion 14A. Note that it is sufficient that the areally increased portion 14A is provided in the smallest necessary range in the lower portion of the outer peripheral surface of the pipe 10, and the areally increased portion 14A may also be provided in a range (the lower end portion, for example) that is smaller than the lower half portion of the outer peripheral surface of the pipe 10.

### Third Embodiment

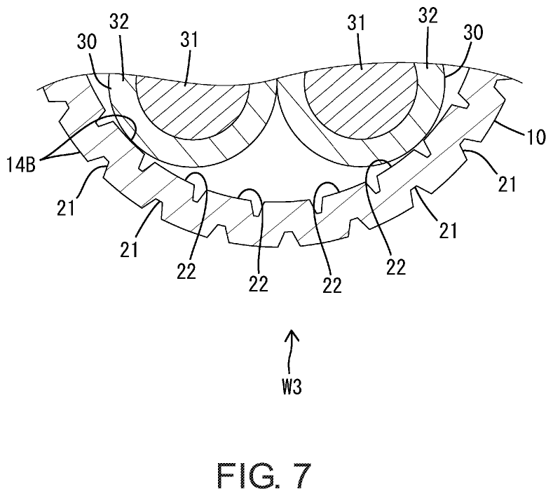

FIG. 7 is a partially enlarged cross-sectional view of a wire harness W3 according to a third embodiment. In the third embodiment, areally increased portions 14B are provided on the outer peripheral surface of the pipe 10, and on the inner peripheral surface of the pipe 10. This point is different to the first embodiment.

For example, the outer peripheral surface of the pipe 10 is pressed with a molding material (not shown) to form a plurality of recessed places 21 that correspond to the molding material in the outer peripheral surface of the pipe 10, and to form a plurality of protruding places 22 that correspond to the recessed places 21 in the inner peripheral surface of the pipe 10. The areally increased portions 14B include the recessed places 21 (including the protruding portions between the recessed places 21) formed in the outer peripheral surface of the pipe 10, and protruding places 22 (including the recessed portions between the protruding places 22) formed on the inner peripheral surface of the pipe 10. According to the third embodiment, the areally increased portions 14B are also provided in the inner peripheral surface of the pipe 10, therefore increasing the area through which heat is dissipated and making it possible to further improve heat dissipation.

### Fourth Embodiment

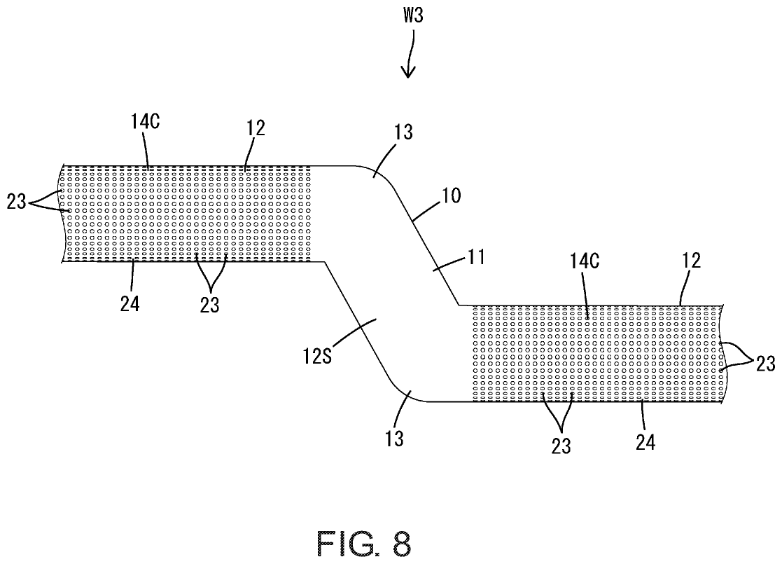

FIGS. 8 to 10 show the pipe 10 and a wire harness W4 according to a fourth embodiment. The areally increased portions 14C in the fourth embodiment include a plurality of dimple recessed portions 23 (recessed portions in the shape of dimples). This point is different to the first embodiment.

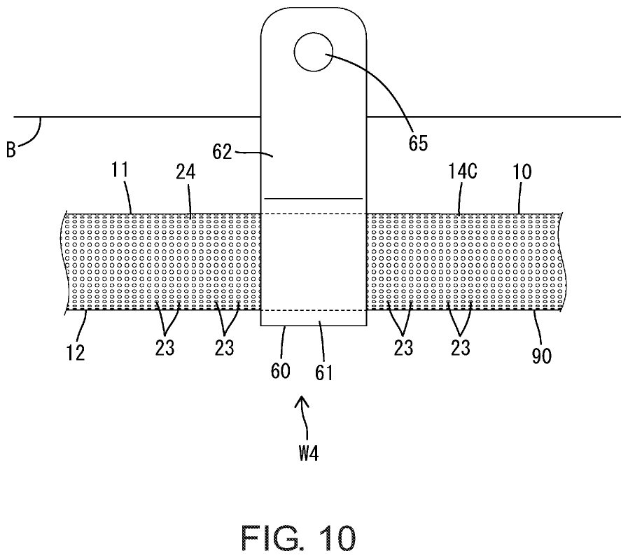

As shown in FIG. 8, the areally increased portions 14C are provided on the outer peripheral surface of the pipe 10 in the straight-pipe portions 12 of the underfloor portion 11. As shown in FIG. 10, the areally increased portions 14C are held by the holding portion 61 of the clamp 60. The pipe 10 is attached to the automotive body B via the clamp 60. These points are similar to the first embodiment.

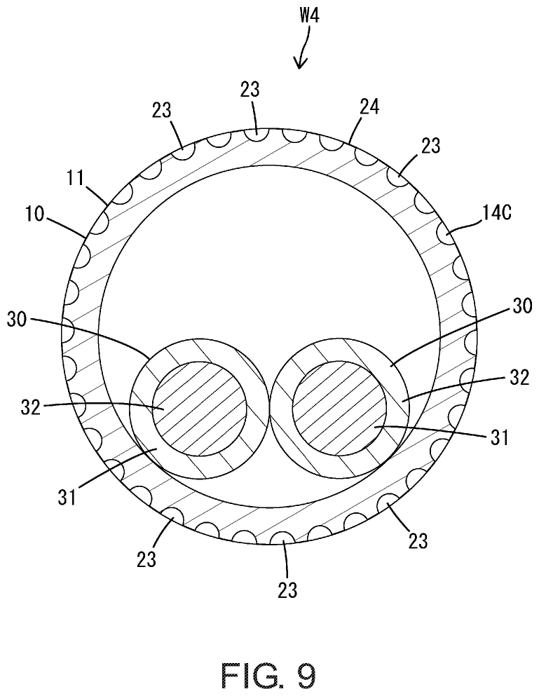

The plurality of dimple recessed portions 23 in the outer peripheral surface of the pipe 10 are provided individually with spaces therebetween in the circumferential direction and the axial direction of the pipe 10. As shown in FIG. 9, the dimple recessed portions 23 have a curved-recessed shape overall and have a circular arc-shaped (specifically, a semi-circular arc-shaped) cross-section. Of course, configurations are also possible in which the dimple recessed portions 23 have a polygonal cross-section such as that of a rectangle, a square, a parallelogram, a trapezoid, or a triangle.

The plurality of dimple recessed portions 23 are arranged aligned in the circumferential direction and the axial direction of the pipe 10. The dimple recessed portions 23 that are lined up in the circumferential direction of the pipe 10 are arranged in the same positions in the axial direction of the pipe 10. The dimple recessed portions 23 lined up in the axial direction of the pipe 10 are arranged in the same positions in the circumferential direction of the pipe 10.

A surface layer portion 24 of the outer peripheral surface of the pipe 10 is constituted by the surface around the openings of the dimple recessed portions 23. The surface layer portion 24 of the outer peripheral surface of the pipe 10 is arranged parallel with the inner peripheral surface of the pipe 10.

The first step to manufacturing the pipe 10 is for the base material of the pipe 10, which has a circular tube shape overall, to be formed through extrusion molding. Next, a molding material (not shown) corresponding to the dimple recessed portions 23 is pressed against the outer peripheral surface of the base material of the pipe 10. The outer peripheral surface of the pipe 10 is plastically deformed by the pressing described above. The areally increased portions 14C, which include the dimple recessed portions 23, are formed on the outer peripheral surface of the pipe 10. Lastly, the pipe 10 and the wire harness W4 are manufactured with similar procedures as those described in the first embodiment.

With the fourth embodiment, the heat that is generated by the wires 30 when the wires 30 conduct electricity can be efficiently released into the air via the areally increased portions 14C. In particular, with the fourth embodiment, it is possible to easily change the number and arrangement of the dimple recessed portions 23, and therefore it is possible to suitably adjust the amount of area of the outer peripheral surface of the pipe 10 that is occupied by the dimple recessed portions 23.

### Other Embodiments of the Present Disclosure

It should be appreciated that the embodiments disclosed herein are to be construed in all respects as illustrative and not limiting.

In the embodiments described above, the pipe is made of a metal, but in other embodiments the pipe may also be a tube member made from a resin, or a composite tube constituted by layers of resin and metal.

In the embodiments described above, the wire harness is a shielding type wire harness that includes a shield member or the like, but in other embodiments the wire harness may also be a non-shielding type wire harness that does not include a shield member or the like.

In the embodiments described above, the areally increased portion is formed through pressing after the base material of the pipe has been extrusion molded, but in other embodiments the areally increased portion may be formed by pressing a planar base material that extends in a plane. In other embodiments, the pipe can be manufactured by rolling a planar base material into a circular tube after the areally increased portion is formed.

In the fourth embodiment described above, the plurality of dimple recessed portions are formed over the entire periphery of the outer peripheral surface of the pipe, but in other embodiments the plurality of dimple recessed portions may also be formed only on the lower portion of the outer peripheral surface of the pipe, as in the second embodiment.

In the third embodiment described above, the areally increased portion is formed over the entire periphery of the inner and outer peripheral surfaces of the pipe, but in other embodiments the areally increased portion may also be formed only on the lower portion of the inner and outer peripheral surfaces of the pipe, as in the second embodiment.

In the third embodiment described above, the outer peripheral surface of the pipe is provided with recessed places in the outer peripheral surface of the pipe and is provided with protruding places on the inner peripheral surface of the pipe, but in other embodiments, instead of the recessed places, the outer peripheral surface of the pipe may also be provided with the embossed recessed portions described in the first embodiment, or may also be provided with the dimpled recessed portions described in the fourth embodiment.

What is claimed is:

1. A pipe configured to have a wire inserted into an internal portion thereof, the pipe comprising:
a body with an areally increased portion, wherein
the areally increased portion has recesses formed into a peripheral surface of the body.

2. The pipe according to claim 1, wherein the areally increased portion is embossed around protrusions formed between the recesses.

3. The pipe according to claim 1, wherein the recesses include a plurality of dimpled recesses provided individually.

4. The pipe according to claim 1, wherein the areally increased portion is provided on a lower portion of the peripheral surface of the body.

5. The pipe according to claim 1, wherein
the body includes a straight-pipe portion that extends in an axial direction and a bent-pipe portion that is bent in a direction that intersects the axial direction, and
the areally increased portion is not provided on the bent-pipe portion and is provided on the straight-pipe portion.

6. The pipe according to claim 1, wherein the areally increased portion is provided on an outer peripheral surface of the body.

7. The pipe according to claim 6, wherein the areally increased portion is also provided on an inner peripheral surface of the body.

8. A wire harness comprising:
the pipe according to claim 1, and
a plurality of wires that are configured to be inserted inside the body.

9. The wire harness according to claim 8, further comprising:
a clamp that is configured to attach the body to an automotive body, wherein
the areally increased portion is provided, in an outer peripheral surface of the body, as a portion that is embossed around protrusions formed between the recesses, or as a portion including a plurality of dimpled recesses provided individually, and
the clamp is configured to hold a region of an outer peripheral surface of the body that includes the areally increased portion.
